(19) United States
(12) Patent Application Publication
(10) Pub. No.: US 2011/0310104 A1
(43) Pub. Date: Dec. 22, 2011

(54) DIGITAL COMIC BOOK FRAME TRANSITION METHOD

(76) Inventor: Ronald DICKE, Ottawa (CA)

(21) Appl. No.: 13/162,796

(22) Filed: Jun. 17, 2011

Related U.S. Application Data
(60) Provisional application No. 61/356,130, filed on Jun. 18, 2010.

(51) Int. Cl. G06T 13/00

(52) U.S. Cl. 345/473

(57) ABSTRACT

A method is provided in which, during a first period of time, first data relating to a first frame of a digital comic book are displayed via an electronic display device. The displayed first data includes a first content element. During a second period of time, second data relating to a second frame of the digital comic book is displayed via the electronic display device. The displayed second data also includes the first content element. A frame transition effect is displayed during a third period of time intermediate the first period of time and the second period of time. During the third period of time, an animation sequence is displayed depicting translation of the first content element between a location of the first content element in the displayed first data and a location of the first content element in the displayed second data. In particular, the animation sequence is displayed superimposed on the frame transition effect.

### FIELD OF THE INVENTION

The instant invention relates generally to methods and systems for distributing digital content, and more particularly to methods and systems for navigating through digitized content arranged sequentially in specified shapes, such as panels of digital comic books.

### BACKGROUND OF THE INVENTION

Publishers of content traditionally offered on paper have begun to digitize the content for distribution over the Internet. For example, publishers of comic strips, comic books, and graphic novels, have begun digitizing their current and classic stories into graphical image formats that can be displayed by software programs. The digitized content is then stored in a repository or on a web server and made available to users to download at their convenience. Alternatively, some digitized comic books are being offered as collections for purchase on DVD or similar format, for perusal on personal computers or through other devices capable of reading and playing DVDs.

When a comic book or similar illustrated content is offered in digital form, each page or double page spread can be stored as a single image such as a “PDF” file, a “GIF” file or a “TIFF” file. A person wishing to read the digital comic uses a software program that can process and render such images, and reads the pages one at a time. One drawback of such an approach is that illustrated works such as comics often contain tremendous detail and color in the drawings as well as small text which may be difficult to see, much less appreciate, without dramatically enlarging the image using the software program that is processing the image.

One way to enlarge the image of, for example, a comic book page, is to modify the scale, zoom or similar setting in the image reader until a desired portion of a page is sufficiently large to allow for viewing of all the interesting details. However, a reader would then need to continuously scale or zoom in and out from the page to see an entire panel of a comic book page or to read other portions or panels of the page. The reader would also be required to scroll up/down or left/right until the next portion or panel of the page is properly positioned on the reader's screen. This is made particularly difficult because the size, shape and positioning of panels on a comic book page vary from page to page, at the whim of the illustrator. The need for the reader to continuously adjust and re-adjust the software settings and scroll around the page reduces the overall enjoyment of reading the content in digitized form.

Another way to enlarge the image of, for example, a comic book page, is to define a plurality of frames of known size, shape, location, etc. For instance, a comic book page that contains a plurality of panels is divided into a plurality of separate frames, each frame containing at least one panel of the plurality of panels. Since each frame represents only a portion of a full page of the comic book, the content of each frame is enlarged relative to a full-page view when the frame is sized for being displayed via a display device. In order to preserve some of the artistic appeal and continuity of the original comic book page, each fame optionally includes content in addition to the at least one panel, such as for instance borders surrounding the at least one panel and/or portions of other panels that are adjacent to the at least one panel.

The separate frames are displayed to a reader one at a time in a predetermined sequence, thereby enabling the reader to view the content of an entire comic book page in a frame-wise fashion. Unfortunately, displaying a comic book page as a series of separate frames results in a loss of the cohesion and structure that inherently exists between the panels when the original comic book page is viewed as a whole. As a result, the reader is more likely to experience difficulty in making connections between the action that is occurring in one frame and the action that is occurring in a next frame. Current techniques for transitioning between the display of adjacent frames, such as for instance by dragging a “viewing window” from one frame to another, fail to establish the cohesion and structure that is necessary to overcome the above-mentioned problem. It would therefore be advantageous to provide a method that overcomes at least some of the above-mentioned limitations.

### SUMMARY OF EMBODIMENTS OF THE INVENTION

In accordance with an aspect of the invention there is provided a method comprising: displaying during a first period of time first data relating to a first frame of a digital comic book, the first data displayed via an electronic display device and the displayed first data including a first content element; displaying during a second period of time second data relating to a second frame of the digital comic book, the second data displayed via the electronic display device and the displayed second data including the first content element; displaying a frame transition effect during a third period of time intermediate the first period of time and the second period of time, the frame transition effect displayed via the electronic display device; and, displaying during the third period of time an animation sequence depicting translation of the first content element between a location of the first content element in the displayed first data and a location of the first content element in the displayed second data, the animation sequence being displayed superimposed on the frame transition effect.

In accordance with an aspect of the invention there is provided a method comprising: receiving data relating to a plurality of panels of digital comic book content; defining a plurality of display frames based on the received data, each display frame comprising at least one panel of the plurality of panels, the plurality of display frames for being displayed to a user via an electronic display device, sequentially and in a predetermined order; defining a content element within each one of a first display frame of the plurality of display frames and a second display frame of the plurality of display frames, the first display frame being immediately adjacent to the second display frame in the predetermined order; defining a frame transition effect for being displayed, via the electronic display device, between the displaying of the first display frame and the displaying of the second display frame; and, defining an animation sequence for being displayed simultaneously with the frame transition effect via the electronic display device, the animation sequence providing a visual representation of movement of the content element between the first display frame and the second display frame.

In accordance with an aspect of the invention there is provided a method comprising: providing an electronic display device having a display portion for displaying digital comic book content in a sequential, frame-wise fashion; providing digital data to the electronic display device, the digital data comprising frame data for being displayed via the display portion as a plurality of individual frames of digital comic book content, and control data for controlling transitions between the display of adjacent frames of the plurality of individual frames of digital comic book content; displaying within the display portion an image of a first frame of the plurality of individual frames of digital comic book content, the first frame including a first content element; based on the control data, replacing the displayed image of the first frame with a displayed image of a second frame of the plurality of individual frames of digital comic book content, the second frame being immediately adjacent to the first frame in a predetermined display order of the plurality of individual frames and the second frame including the first content element; and, based on the control data, during replacing the image of the first frame with the image of the second frame, simultaneously displaying an animation sequence providing a visual representation of movement of the first content element between a location thereof within the displayed first image and a location thereof within the displayed second image.

### BRIEF DESCRIPTION OF THE DRAWINGS

Exemplary embodiments of the invention will now be described in conjunction with the following drawings, in which:

FIG. 1 is a simplified drawing showing a page including a plurality of panels of illustrative content;

FIG. 2 is a simplified drawing showing the page of FIG. 1 and including a plurality of defined frames superimposed thereon;

FIG. 3a shows the upper left frame of FIG. 2;

FIG. 3b shows the upper right frame of FIG. 2;

FIG. 3c shows the lower left frame of FIG. 2;

FIG. 3d shows the lower right frame of FIG. 2;

FIG. 4a shows an electronic display device at a first time, during which time a first frame of the page of FIG. 1 is displayed via a display portion thereof;

FIG. 4b shows the electronic display device of FIG. 4a at a second time, during which time the display of the first frame is partially replaced by the display of a frame second frame of the page of FIG. 1;

FIG. 4c illustrates the effect that is created by displaying an animation sequence simultaneously with a push slide transition;

FIG. 4d shows the electronic display device of FIG. 4a at a third time, during which time the second frame of the page 100 is displayed via the display portion thereof;

FIG. 5 illustrates the effect that is created by displaying an animation sequence simultaneously with a cross fade transition;

FIG. 6 is a simplified flow diagram of a method according to an embodiment of the instant invention;

FIG. 7 is a simplified flow diagram of a method according to another embodiment of the instant invention; and,

FIG. 8 is a simplified flow diagram of a method according to yet another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

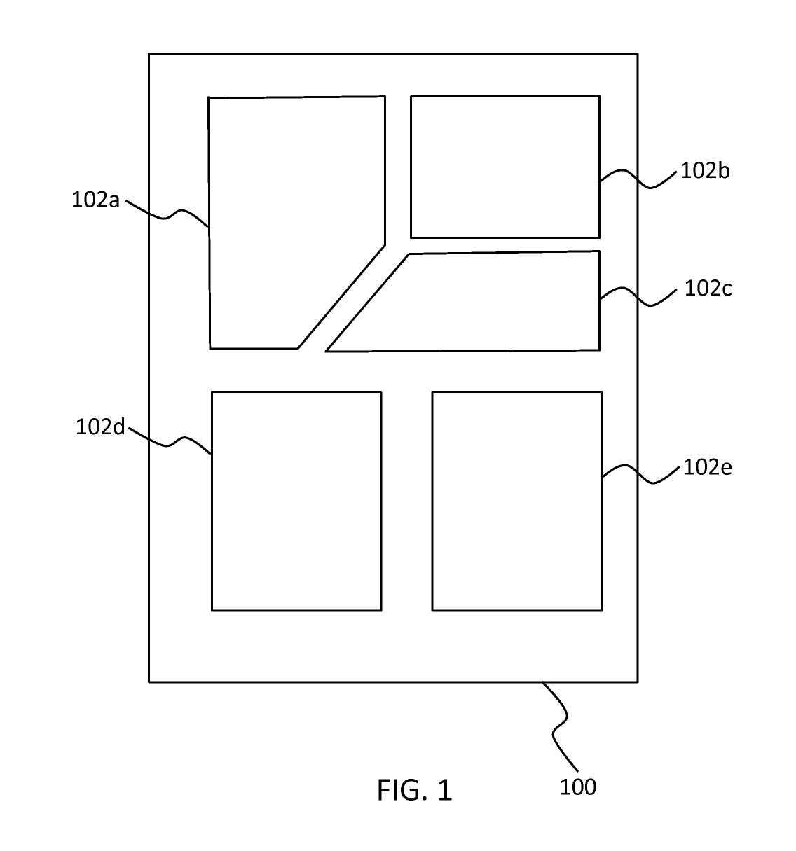

FIG. 1 is a simplified drawing showing a page 100 including a plurality of panels of illustrative content 102a-e, which are intended to be read by a reader in the order 102a, 102b, 102c, 102d, 102e. In the instant example it is assumed that the illustrative content is confined within the outlines of the panel boxes 102a-e, and that adjacent panels are separated one from another by a border. Of course, using different artistic styles may result in panels that overlap one another, panels without readily identifiable boundaries, non-traditional flow of illustrative content, etc.

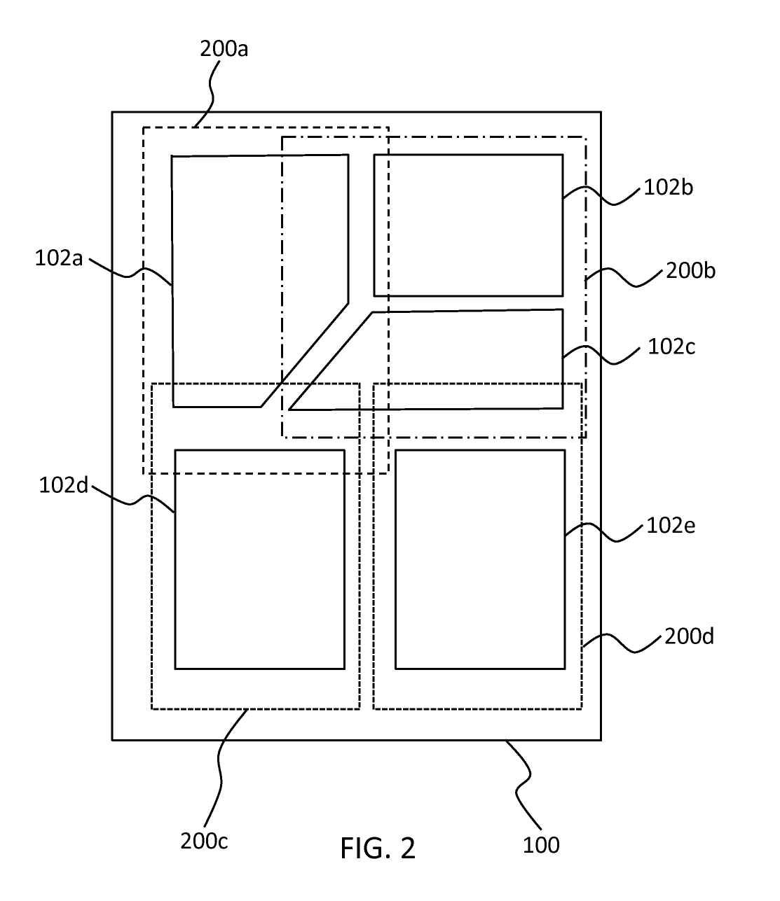

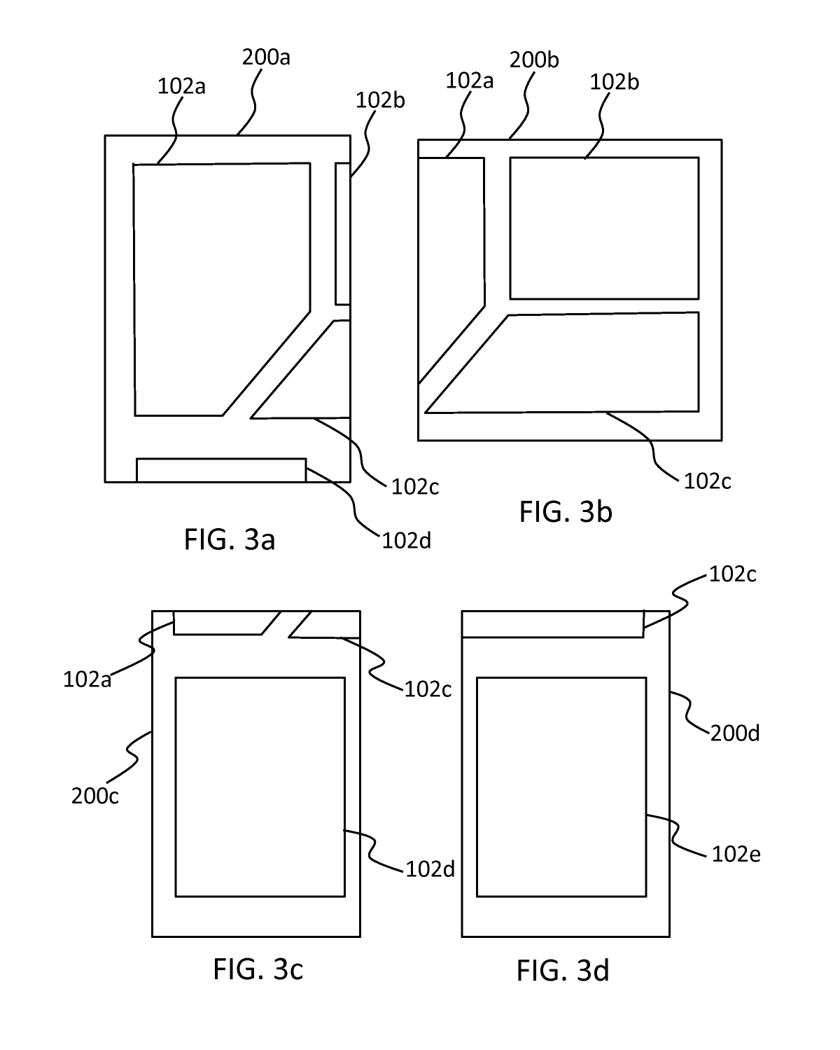

FIG. 2 is a simplified drawing showing the page 100 and including a plurality of defined frames 200a-d superimposed thereon. Frames 202a-d are also shown separately in FIGS. 3a-d, respectively, in which the relative positioning of the panels 102a-e is the same as in FIGS. 1 and 2. In the instant example the frames are of various sizes and of various shapes, being defined in dependence upon the particular panel layout of the page 100. More particularly, the frames 202a-d are defined such that the content contained therein, when viewed via the display portion of an electronic display device, is sufficiently detailed and sufficiently enhanced so as to be readily appreciated by a reader. As is shown in FIG. 2 and in FIGS. 3a-d, the frames optionally overlap portions of other frames, contain portions of adjacent panels, and/or contain more than one whole panel. For instance, frame 200a includes all of panel 102a as well as portions of the surrounding panels 102b, 102c and 102d. On the other hand, frame 200b includes whole panels 102b and 102c as well as a portion of panel 102a. By including portions of adjacent panels, borders around panels, and even edges of the page 100 within the frames 200a-d, the overall artistic impression of the page 100 is better maintained when the frames 200a-d are displayed one at a time via the display portion of the electronic display device.

One way of defining the frames 202a-d includes digitizing page 100 and displaying the digitized page 100 on a display portion of a computer system. Optionally, digitizing page 100 is performed either by scanning a version of page 100 that is printed on paper or by creating page 100 using a computer assisted drawing program and storing the product as a computer readable data file. Using a suitable software package, a user subsequently defines frames 202a-d by placing boxes onto a displayed image of the digitized page 100, and then sizing and positioning the boxes in order to achieve a desired frame layout effect, such as is as shown in FIG. 2. Once the frame layout is finalized, frame definition data is determined for the page 100. By way of a specific and non-limiting example, the frame layout data defines each frame 202a-d in terms of a height and width thereof, as well as in terms of a position thereof on the page 100. The frame definition data is stored in association with content data for page 100, and is provided with the content data for page 100 in response to a reader requesting the content data for page 100.

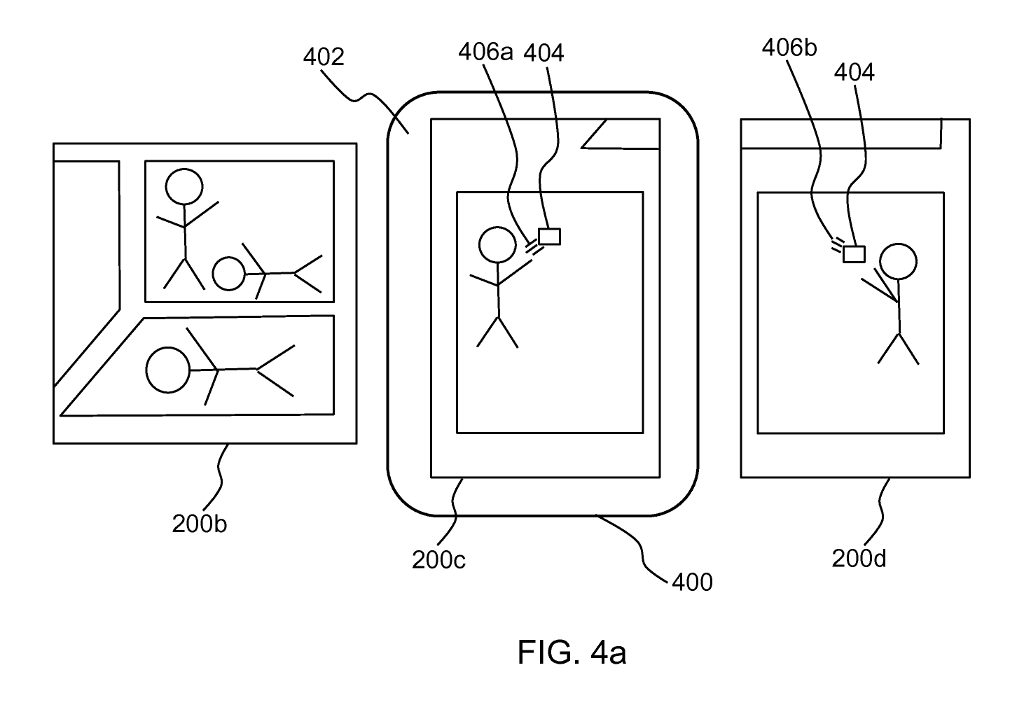

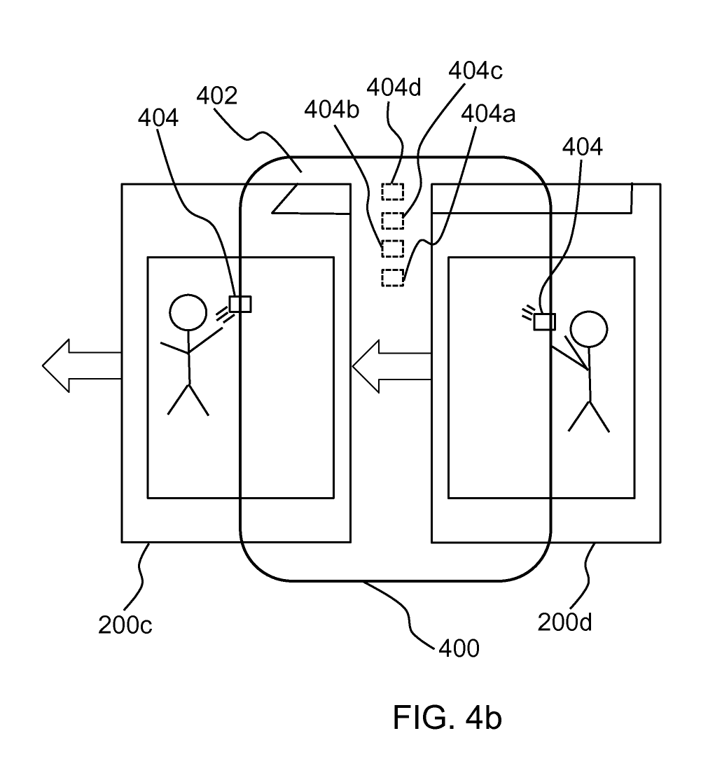

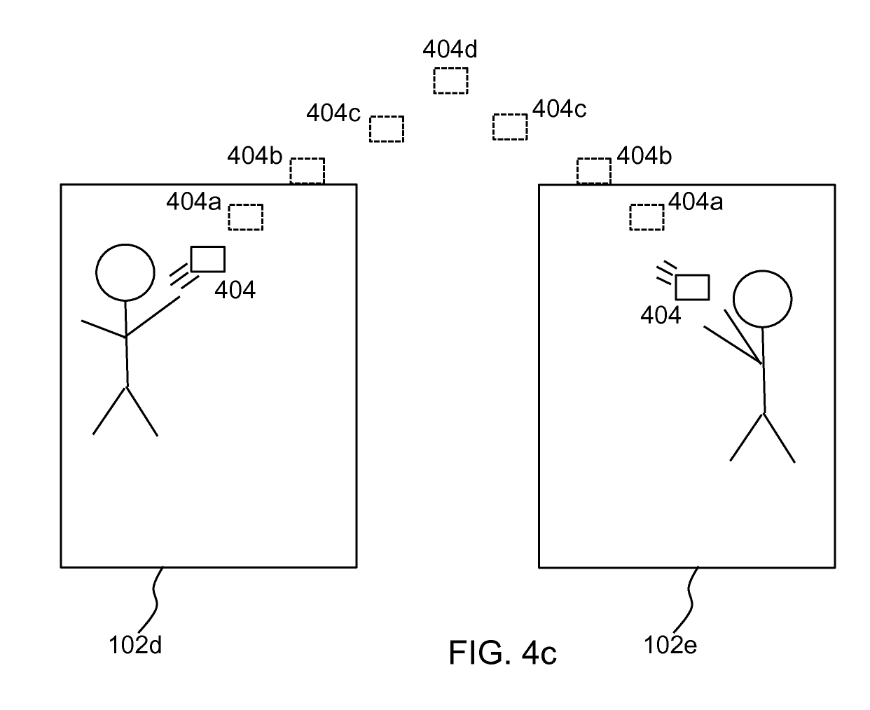

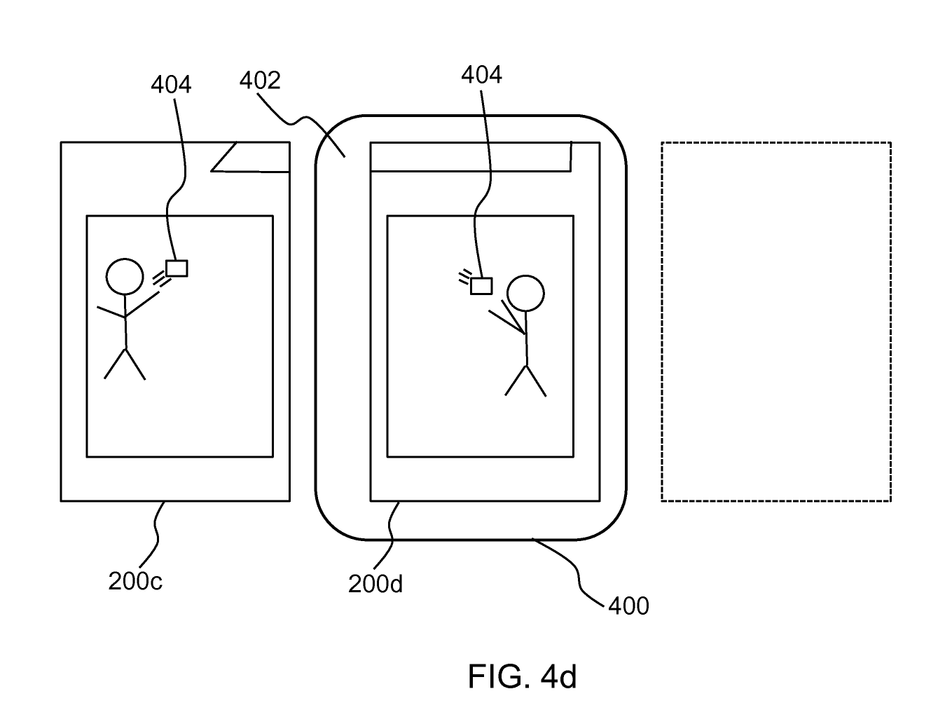

Referring now to FIGS. 4a-d, shown is a method for transitioning between the displaying of sequential frames of a digital comic book page 100, according to an embodiment of the instant invention. The display of frames in FIGS. 4a-d is based on content data for the page 100 as well as frame definition data relating to the frames. By way of a specific and non-limiting example, individual frames 200a-d are extracted from the page 100 content data, based on the frame definition data associated therewith. Optionally, each one of the frames 200a-d is scaled to fit a display portion of a display device prior to being displayed thereon.

FIG. 4a shows an electronic display device 400 at a first time, during which time a current frame 200c of the page 100 is displayed via a display portion 402 of the electronic display device 400. In order to facilitate an understanding of the instant embodiment, a previously displayed frame 200b is shown on the left-hand side of electronic display device 400 in FIG. 4a, and a next frame 200d is shown on the right-hand side of the electronic display device 400 in FIG. 4a. It is to be understood that the frames 200b, 200c and 200d are each displayed one at a time via the display portion 202 of display device 204, and that they are shown simultaneously in FIG. 4a merely for illustrative purposes.

Referring still to FIG. 4a, each one of the frames 200c and 200d includes a first content element 404. In the instant example, the content element 404 is an element with apparent movement between the frame 200c and the frame 200d, as is indicated diagrammatically using directional “flight lines” 406a and 406b. When viewing the page 100 as a whole, such that the panel 102d is situated immediately to the left of the panel 102e, a reader is able to interpret the motion of the content element 404 from left to right between the two panels 102d and 102e. In other words, the position of panel 102d relative to 102e provides a visual cue when the page 100 is viewed as a whole, which the reader uses in order to recognize movement from one panel to another. Of course, when the frames 102d and 102e are viewed separately the reader does not have the same visual cue, and accordingly finds it more difficult to recognize movement between panels.

FIG. 4b shows the electronic display device 400 at a second time, during which time the display of the frame 200c is partially replaced by the display of the frame 200d. In particular, FIG. 4b illustrates a push slide transition whereby the frame 200d appears to push the frame 200c from right to left across the display portion 402 of the electronic display device 400. In order to provide a visual cue to help the reader recognize movement of the content element 404 between frame 200c and 200d, an animation sequence 404a-d is displayed simultaneously with the transition.

Referring still to FIG. 4b, the content element 404 is part of each of the frames 200c and 200d, and therefore moves with the frames during the push slide transition. FIG. 4b also shows the animation sequence as indicated by the dashed-line boxed 404a-d. The animation sequence is displayed during the push slide transition, so as to convey the impression that content element 404 is moving out of frame 200c, through the space between frame 200c and frame 200d, and finally into frame 200d. In the instant example, the dashed-line boxes are displayed in the order 404a, 404b, 404c, 404d, 404c, 404b, and 404a.

FIG. 4c shows only the panels 102d and 102e of FIG. 4b, and illustrates the effect that is created by displaying an animation sequence simultaneously with the push slide transition. Since the content of the panels 102d and 102e is moving right to left across the display portion of the electronic device, the column of dashed-line boxes when displayed in the order 404a, 404b, 404c, 404d, 404c, 404b, and 404a appear to trace an arc between the content element 404 in panel 102d and the content element 404 in panel 102e. FIGS. 4b and 4c show a simplified example in which the location of content element 404 is the same in both frames 200c and 200d. Optionally, when the location of content element 404 is different in frames 200c and 200d the animation sequence is adjusted such that the content element appears to trace an arc or other trajectory between the location thereof in frame 200c and the location thereof in frame 200d. Optionally, the duration of the animation sequence is shorter than the duration of the transition effect, such that the animation of the content element is initiated after the frames have transitioned by a predetermined amount and/or is terminated before the frames have transitioned fully.

FIG. 4d shows the electronic display device 400 at a third time, during which time the next frame 200d of the page 100 is displayed via the display portion 402 of the electronic display device 400. For illustrative purposes, the previously displayed frame 102c is shown on the left hand side of display device 400. Of course, since in the instant example frame 200d is the final frame on page 100, no additional frames are shown on the right hand side of display device 200. By the time the frame 200d is displayed via the display portion 402 of the electronic device 400, the reader is able to use the visual cue provided by the animation sequence and recognize that movement of the content element 404 between frame 200c and frame 200d has occurred.

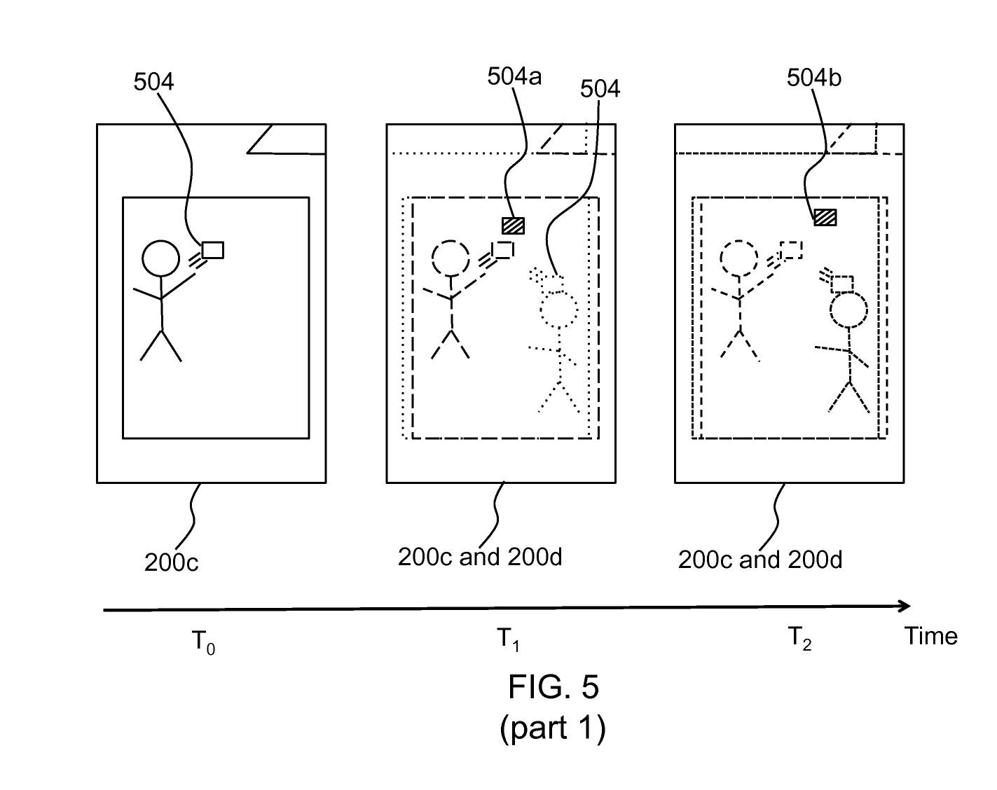

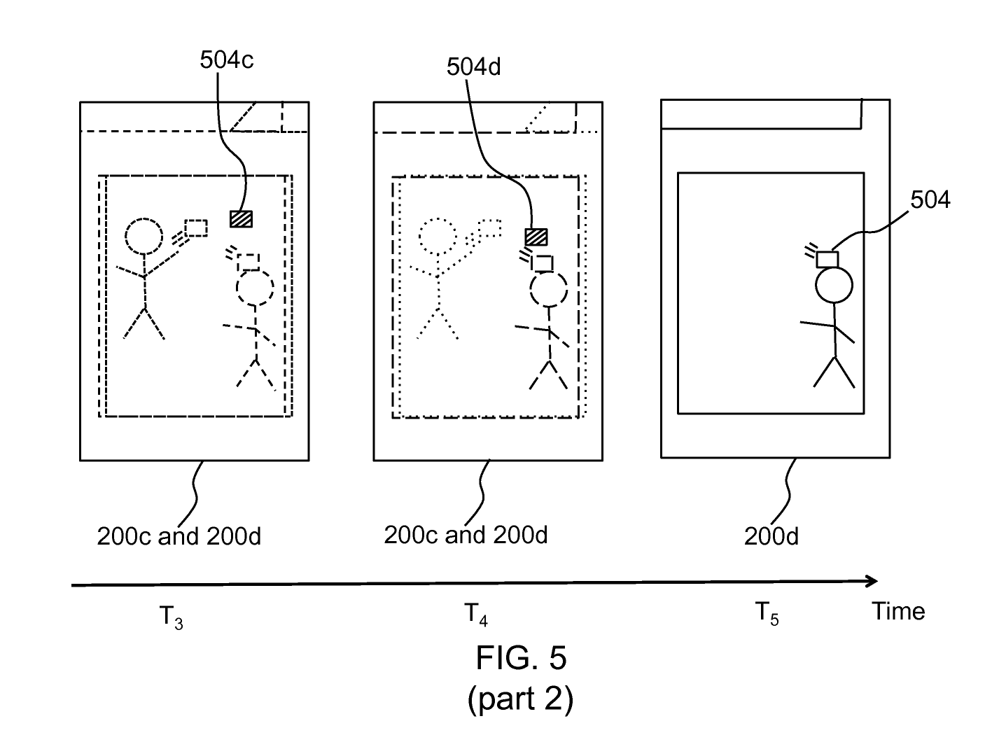

Referring now to FIG. 5, shown is a method for transitioning between the displaying of sequential frames of a digital comic book, according to another embodiment of the instant invention. The display of individual frames in FIG. 5 is based on content data for the page 100, as well as frame definition data. By way of a specific and non-limiting example, individual frames 200a-d are extracted from the page 100 content data based on the frame definition data associated therewith. Optionally, each one of the frames 200a-d is scaled to fit a display portion of a display device prior to being displayed thereon.

A reference time axis is drawn along the bottom of FIG. 5, which is continuous from part 1 to part 2 thereof, and along which is shown a sequence of simulated images as displayed via an electronic display device (not shown), according to the instant embodiment. At time T₀ frame 200c is displayed, including a content element 504 that is also present in a next frame to be displayed, frame 200d. Time T₁ corresponds to the initiation of a cross fade transition effect and the approximately simultaneous initiation of an animation sequence. In particular, at T₁ the display of frame 200c begins to fade slightly and the display of frame 200d, which also includes content element 504, begins to appear within the same display area of the electronic display device. In the instant example, the location of content element 504 in frame 200c is different than the location of content element 504 in frame 200d. Accordingly, the animation sequence begins with the display of animated content element 504a at a location along a trajectory between the location of content element 504 in frame 200c and the location of content element 504 in frame 200d. As the cross fade transition progresses to time T₂, T₃, and T₄, frame 200c is displayed with progressively less weight relative to frame 200d. In addition, the animated content element is displayed at locations 504b, 504c and 504d, which are progressively further along the trajectory between the location of content element 504 in frame 200c and the location of content element 504 in frame 200d. Finally, at time T₅ the cross fade transition is complete and the display of the animated content element has terminated, such that frame 200d is displayed via the electronic display device. By the time the frame 200d is displayed, the reader is able to use the visual cue provided by the animation sequence and recognize that movement of the content element 504 between frame 200c and frame 200d has occurred.

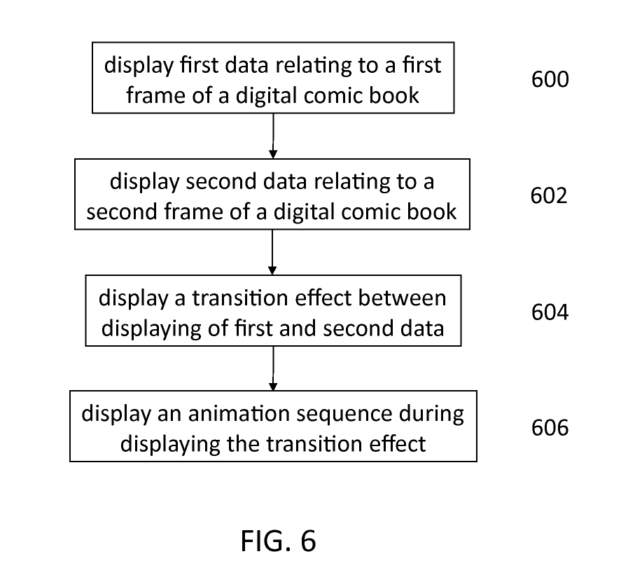

Referring now to FIG. 6, shown is a simplified flow diagram of a method according to an embodiment of the instant invention. At 600 first data relating to a first frame of a digital comic book are displayed during a first period of time, the first data being displayed via an electronic display device and the displayed first data including a first content element. At 602 second data relating to a second frame of the digital comic book are displayed during a second period of time subsequent to the first period of time, the second data being displayed via the electronic display device and the displayed second data including the first content element. For instance, the first content element is an identifiable object or an identifiable character within the first frame and within the second frame. Optionally, the first content element has motion associated therewith in the context of the digital comic book content. In other words, the first content element is intended to be perceived as moving between the first frame and the second frame of the digital comic book. Alternatively, the first content element is merely present in each of the first frame and the second frame, but it is not intended to be perceived as moving between the frames. At 604 a frame transition effect is displayed during a third period of time intermediate the first period of time and the second period of time, the frame transition effect also displayed via the electronic display device. For instance, the frame transition effect is one of a push slide transition effect and a cross fade transition effect. At 606, during the third period of time, an animation sequence is displayed depicting translation of the first content element between a location of the first content element in the displayed first data and a location of the first content element in the displayed second data, the animation sequence being displayed superimposed on the frame transition effect. The animation effect establishes connectivity between the first content element in the first frame and in the second frame, which optionally also depicts motion of the content element between the first frame and the second frame. Of course, optionally another type of transition effect is displayed between displaying of the first frame and displaying of the second frame.

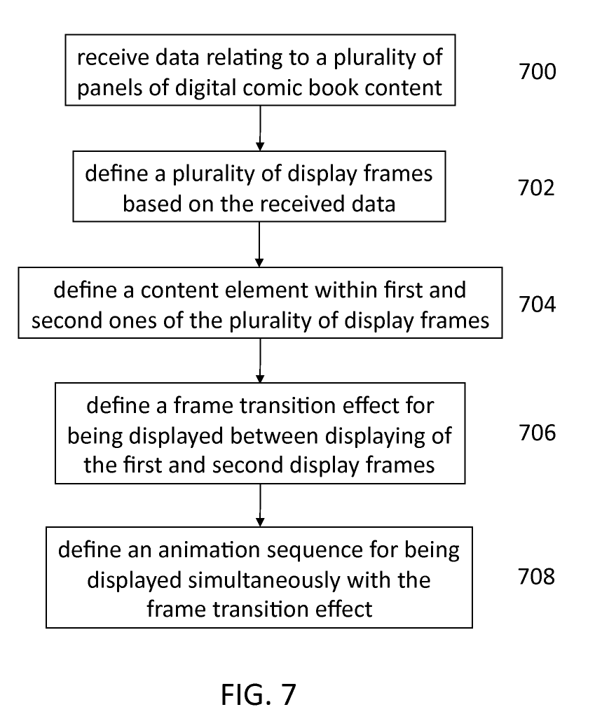

Referring now to FIG. 7, shown is a simplified flow diagram of a method according to another embodiment of the instant invention. At 700 data are received relating to a plurality of panels of digital comic book content. At 702 a plurality of display frames is defined based on the received data, each display frame comprising at least one panel of the plurality of panels. In particular, display frames of the plurality of display frames are for being displayed to a user via an electronic display device, sequentially and in a predetermined order. At 704 a content element is defined within each one of a first display frame of the plurality of display frames and a second display frame of the plurality of display frames, the first display frame being immediately adjacent to the second display frame in the predetermined order. For instance, the content element is an identifiable object or an identifiable character within the first display frame and within the second display frame. The content element has motion associated therewith in the context of the digital comic book content. In other words, the content element is intended to be perceived by the reader as moving between the first display frame and the second display frame of the digital comic book. At 706 a frame transition effect is defined for being displayed, via the electronic display device, between the displaying of the first display frame and the displaying of the second display frame. For instance, the frame transition effect is one of a push slide transition effect and a cross fade transition effect. At 708 an animation sequence is defined for being displayed simultaneously with the frame transition effect via the electronic display device, the animation sequence providing a visual representation of movement of the content element between the first display frame and the second display frame. Alternatively, the content element is merely present in each of the first display frame and the second display frame, but it is not intended to be perceived by the reader as moving between the frames. In this alternative situation the animation sequence merely provides a visual representation of connectivity between the content element in the first display frame and in the second display frame, but does not represent motion of the content element between the first display frame and the second display frame.

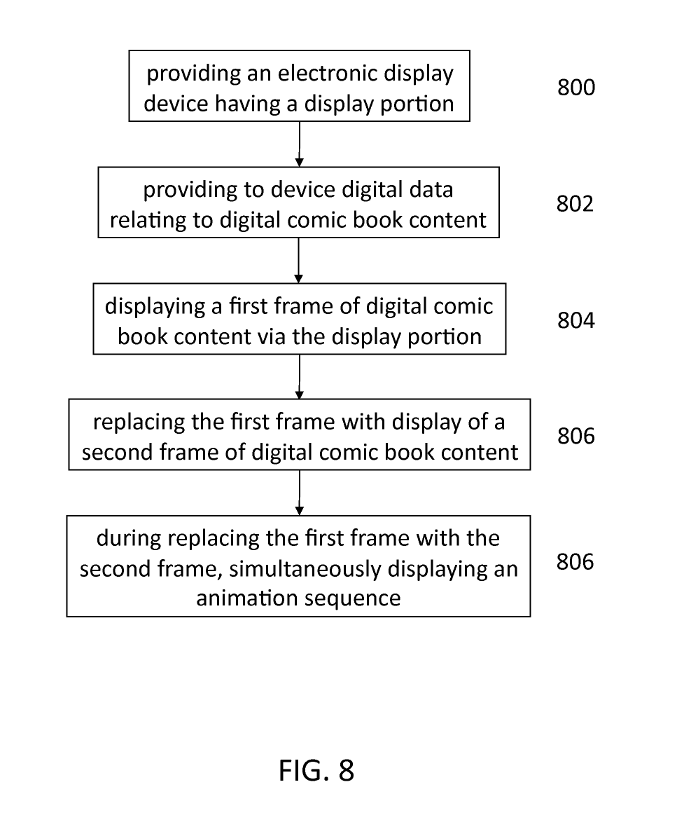

Referring now to FIG. 8, shown is a simplified flow diagram of a method according to yet another embodiment of the instant invention. At 800 an electronic display device having a display portion is provided for displaying digital comic book content in a sequential, frame-wise fashion. At 802 digital data is provided to the electronic display device. In particular the digital data comprises frame data for being displayed via the display portion as a plurality of individual frames of digital comic book content, and control data for controlling transitions between the displaying of adjacent frames of the plurality of individual frames of digital comic book content. At 804 an image of a first frame of the plurality of individual frames of digital comic book content is displayed within the display portion, the first frame including a first content element. At 806, based on the control data, the displayed image of the first frame is replaced with a displayed image of a second frame of the plurality of individual frames of digital comic book content. In particular, the second frame is immediately adjacent to the first frame in a predetermined display order of the plurality of individual frames, and the second frame includes the first content element. At 808, based on the control data, an animation sequence is displayed during replacing the image of the first frame with the image of the second frame, so as to provide a visual representation of movement of the first content element between a location thereof within the displayed first image and a location thereof within the displayed second image. Alternatively, the first content element is merely present in each of the image of the first frame and the image of the second frame, but it is not intended to be perceived by the reader as moving between the frames. In this alternative situation the animation sequence merely provides a visual representation of connectivity between the first content element in the image of the first frame and in the image of the second frame, but it does not represent motion of the first content element between the image of the first frame and the image of the second frame.

Numerous other embodiments may be envisaged without departing from the scope of the invention.

What is claimed is:

1. A method comprising:
displaying during a first period of time first data relating to a first frame of a digital comic book, the first data displayed via an electronic display device and the displayed first data including a first content element;
displaying during a second period of time second data relating to a second frame of the digital comic book, the second data displayed via the electronic display device and the displayed second data including the first content element;
displaying a frame transition effect during a third period of time intermediate the first period of time and the second period of time, the frame transition effect displayed via the electronic display device; and,
displaying during the third period of time an animation sequence depicting translation of the first content element between a location of the first content element in the displayed first data and a location of the first content element in the displayed second data, the animation sequence being displayed superimposed on the frame transition effect.

2. A method according to claim 1, wherein during the third period of time the electronic display device displays simultaneously, in a human intelligible form, at least a portion of the first frame of the digital comic book and at least a portion of the second frame of the digital comic book.

3. A method according to claim 1, wherein the transition effect is a cross fade transition effect.

4. A method according to claim 1, wherein the transition effect is a push slide transition effect.

5. A method according to claim 1, wherein a duration of the animation sequence is substantially equal to a duration of the frame transition effect.

6. A method according to claim 1, wherein a duration of the animation sequence is shorter than a duration of the frame transition effect.

7. A method comprising:
receiving data relating to a plurality of panels of digital comic book content;
defining a plurality of display frames based on the received data, each display frame comprising at least one panel of the plurality of panels, the plurality of display frames for being displayed to a user via an electronic display device, sequentially and in a predetermined order;
defining a content element within each one of a first display frame of the plurality of display frames and a second display frame of the plurality of display frames, the first display frame being immediately adjacent to the second display frame in the predetermined order;
defining a frame transition effect for being displayed, via the electronic display device, between the displaying of the first display frame and the displaying of the second display frame; and,
defining an animation sequence for being displayed simultaneously with the frame transition effect via the electronic display device, the animation sequence providing a visual representation of movement of the content element between the first display frame and the second display frame.

8. A method according to claim 7, wherein defining a plurality of display frames comprises determining frame definition data indicative of a size and indicative of a location within the digital comic book content for each display frame of the plurality of display frames.

9. A method according to claim 7, wherein defining an animation sequence comprises generating at least an image of the content element for being displayed via the electronic display device at locations that are between the location of the content element in the first display frame and the location of the content element in the second display frame during displaying of the frame transition effect.

10. A method according to claim 7, wherein the frame transition effect is a cross fade transition effect.

11. A method according to claim 7, wherein the frame transition effect is a push slide transition effect.

12. A method according to claim 7, wherein a duration of the defined animation sequence is substantially equal to a duration of the defined frame transition effect.

13. A method according to claim 7, wherein a duration of the defined animation sequence is shorter than a duration of the defined frame transition effect.

14. A method comprising:
providing an electronic display device having a display portion for displaying digital comic book content in a sequential, frame-wise fashion;
providing digital data to the electronic display device, the digital data comprising frame data for being displayed via the display portion as a plurality of individual frames of digital comic book content, and control data for controlling transitions between the display of adjacent frames of the plurality of individual frames of digital comic book content;
displaying within the display portion an image of a first frame of the plurality of individual frames of digital comic book content, the first frame including a first content element;
based on the control data, replacing the displayed image of the first frame with a displayed image of a second frame of the plurality of individual frames of digital comic book content, the second frame being immediately adjacent to the first frame in a predetermined display order of the plurality of individual frames and the second frame including the first content element; and,
based on the control data, during replacing the image of the first frame with the image of the second frame, simultaneously displaying an animation sequence providing a visual representation of movement of the first content element between a location thereof within the displayed first image and a location thereof within the displayed second image.

15. A method according to claim 14, wherein during replacing the image of the first frame with the image of the second frame, the electronic display device displays simultaneously, in a human intelligible form, at least a portion of the first frame and at least a portion of the second frame.

16. A method according to claim 14, comprising displaying via the display portion a transition effect during replacing the image of the first frame with the image of the second frame.

17. A method according to claim 16, wherein the transition effect is a cross fade transition effect.

18. A method according to claim 16, wherein the transition effect is a push slide transition effect.

19. A method according to claim 16, wherein a duration of the animation sequence is substantially equal to a duration of the transition effect.

20. A method according to claim 16, wherein a duration of the animation sequence is shorter than a duration of the transition effect.
